(19) United States
(12) Patent Application Publication
(10) Pub. No.: US 2013/0110569 A1
(43) Pub. Date: May 2, 2013

(54) SYSTEMS AND METHODS TO SCHEDULE DEMAND RESPONSE EVENTS

(71) Applicants: Mark Joseph Meyerhofer, Acworth, GA (US); Chad Eric Knodle, Marietta, GA (US); James Joseph Schmid, Acworth, GA (US); Jerry Steven Massey, Lawrenceville, GA (US); Bobby Antione Wilson, Lithia Springs, GA (US); Jaime Alberto Sierra, Atlanta, GA (US)

(72) Inventors: Mark Joseph Meyerhofer, Acworth, GA (US); Chad Eric Knodle, Marietta, GA (US); James Joseph Schmid, Acworth, GA (US); Jerry Steven Massey, Lawrenceville, GA (US); Bobby Antione Wilson, Lithia Springs, GA (US); Jaime Alberto Sierra, Atlanta, GA (US)

(21) Appl. No.: 13/283,502

(22) Filed: Oct. 27, 2011

(51) Int. Cl. G06Q 10/10

(52) U.S. Cl. 705/7.16

(57) ABSTRACT

A computing device for use with a demand response system is provided. The computing device includes a processor that is programmed to select at least one participant from a plurality of customers to participate in at least one demand response event. The processor is also programmed to schedule the demand response event. The processor is programmed to compare the selected participant with participants of previously scheduled demand response events to confirm whether the selected participant is able to participate in the demand response event. The processor is also programmed to compare the demand response event with the previously scheduled demand response events. The processor is further programmed to reschedule the demand response event and/or at least one of the previously scheduled demand response events when any conflicts are identified based on the comparison between the demand response event and the previously scheduled demand response events.

### BACKGROUND OF THE INVENTION

The field of the invention relates generally to demand response systems and, more particularly, to a computing device for use with a demand response system for scheduling demand response events.

As the human population increases around the world and with an increase in the use of electric vehicles by customers, energy demand will also likely increase. More specifically, energy demand will likely increase in the form of electrical energy used to power buildings, homes, and/or to charge batteries or other energy sources used in electric vehicles. Moreover, the demand on the power grid is likely to increase while the demand for fuel decreases. Such demands will likely cause an increase in the price of energy from the power grid. In particular, the price of energy is likely to increase during peak times, such as a time of day and/or a day of the week, when demand for energy is high.

Currently, at least some known utilities use demand response systems that enable customers to enroll in at least one demand response program to manage the consumption of energy by their customers in response to supply conditions. Examples of demand response programs include a direct control program, a peak pricing program, such as a critical peak pricing program, and a time of use program. The initiation and/or implementation of a demand response program by a utility is known as a demand response event. A demand response event is initiated by a utility transmitting a plurality of signals to its customers. For example, a demand response event representative of a direct load control program, is initiated when the utility transmits a signal to a device within a building, such as an in-home smart device and/or smart thermostat, such that the utility is enabled to directly control the usage of energy consuming machines within the building. A demand response event representative of a peak pricing program occurs when the utility transmits pricing signals to its customers during peak demand times. The pricing signals enable the utility to apprise customers of heightened energy prices during peak demand time periods such that customers may limit their energy consumption during such peak demand time periods. A demand response event representative of a time of use program occurs when the utility transmits a signal to a customer that is representative of energy prices that correspond to a time range such that the customer may identify an optimal time of day and/or day of the week to consume energy to ensure a low energy price rate.

Such demand response systems enable the utility to manage peak load conditions and to reduce energy demand and/or consumption among its customers. More specifically, utilities manage peak load conditions by scheduling a fixed number of demand response events per day, week, and/or month for their customers. However, current demand response systems are unable to target specific customers for participating in a scheduled demand response event and, as a result, all the customers may receive signals from the utility that are representative of a demand response event. Some of the customers may be unnecessarily burdened with receiving the signal, as they may not have agreed to participate in the scheduled event. Moreover, current demand response systems are unable to identify any potential conflicts prior to scheduling a demand response event, such as identifying whether any additional demand response events are scheduled to occur during the same time for any selected participants of the demand response events. As a result, a user, such as an employee of a utility, may be required to look at all scheduled demand response events and their selected participants to identify if any events are scheduled to occur during the same time or if any of the participants exist in any of the other scheduled demand response events. If any conflicts are identified, the user is required to manually reschedule and/or delete demand response events that are in conflict with one another. This process may be time consuming and inefficient.

### BRIEF DESCRIPTION OF THE INVENTION

In one embodiment, a computing device for use with a demand response system is provided. The computing device includes a processor that is programmed to select at least one participant from a plurality of customers to participate in at least one demand response event. The processor is also programmed to schedule the demand response event. The processor is programmed to compare the selected participant with a plurality of participants of a plurality of previously scheduled demand response events to confirm whether the selected participant is able to participate in the demand response event. The processor is also programmed to compare the demand response event with the previously scheduled demand response events. The processor is further programmed to reschedule the demand response event and/or at least one of the previously scheduled demand response events when any conflicts are identified based on the comparison between the demand response event and the previously scheduled demand response events.

In another embodiment, a demand response system is provided. The demand response system includes a data management system that includes a database that includes customer data of a plurality of customers, wherein the customer data includes an enrollment status for each customer in at least one demand response program. The demand response system also includes a computing device coupled to the data management system. The computing device includes a processor that is programmed to select at least one participant from the customers to participate in at least one demand response event. The processor is also programmed to schedule the demand response event. The processor is programmed to compare the selected participant with a plurality of participants of a plurality of previously scheduled demand response events to confirm whether the selected participant is able to participate in the demand response event. The processor is also programmed to compare the demand response event with the previously scheduled demand response events. The processor is further programmed to reschedule the demand response event and/or at least one of the previously scheduled demand response events when any conflicts are identified based on the comparison between the demand response event and the previously scheduled demand response events.

In yet another embodiment, a method for scheduling demand response events is provided. At least one participant is selected from a plurality of customers to participate in at least one demand response event. The demand response event is scheduled. The selected participant is compared with a plurality of participants of a plurality of previously scheduled demand response events to confirm whether the selected participant is able to participate in the demand response event. The demand response event is compared with the plurality of previously scheduled demand response events. The demand response event and/or at least one of the previously scheduled demand response events is rescheduled when any conflicts are identified based on the comparison between the demand response event and the previously scheduled demand response events.

### BRIEF DESCRIPTION OF THE DRAWINGS

FIG. 1 is a block diagram of an exemplary demand response system;

FIG. 2 is a block diagram of an exemplary computing device that may be used with the demand response system shown in FIG. 1; and

FIG. 3 is a flow chart of an exemplary method that may be used for scheduling demand response events using the computing device shown in FIG. 2.

### DETAILED DESCRIPTION OF THE INVENTION

The exemplary systems and methods described herein overcome at least some known disadvantages of known demand response systems by providing an efficient and user friendly demand response system that can be used by a utility to schedule demand response events. The embodiments described herein include a demand response system that includes a computing device, wherein the computing device includes a processor that is programmed to select at least one participant from a plurality of customers to participate in at least one demand response event. The processor is also programmed to schedule the demand response event. The processor is programmed to compare the selected participant with a plurality of participants of a plurality of previously scheduled demand response events to confirm whether the selected participant is able to participate in the demand response event. The processor is also programmed to compare the demand response event with the previously scheduled demand response events. The processor is further programmed to reschedule the demand response event and/or at least one of the previously scheduled demand response events when any conflicts are identified based on the comparison between the demand response event and the previously scheduled demand response events. By selectively targeting only certain customers for participating in a demand response event that is to be scheduled, the burden on every customer may be substantially reduced. In addition, by having the computing device schedule demand response events, while confirming whether selected participants can participate in the demand response event and also while taking any scheduling conflicts with previously scheduled demand response events into account, a user, such as an employee of the utility, is no longer required to look at all scheduled demand response events to identify any conflicts and/or to manually reschedule and/or delete demand response events that are in conflict with one another. Accordingly, the utility is not burdened with a time consuming and/or inefficient process.

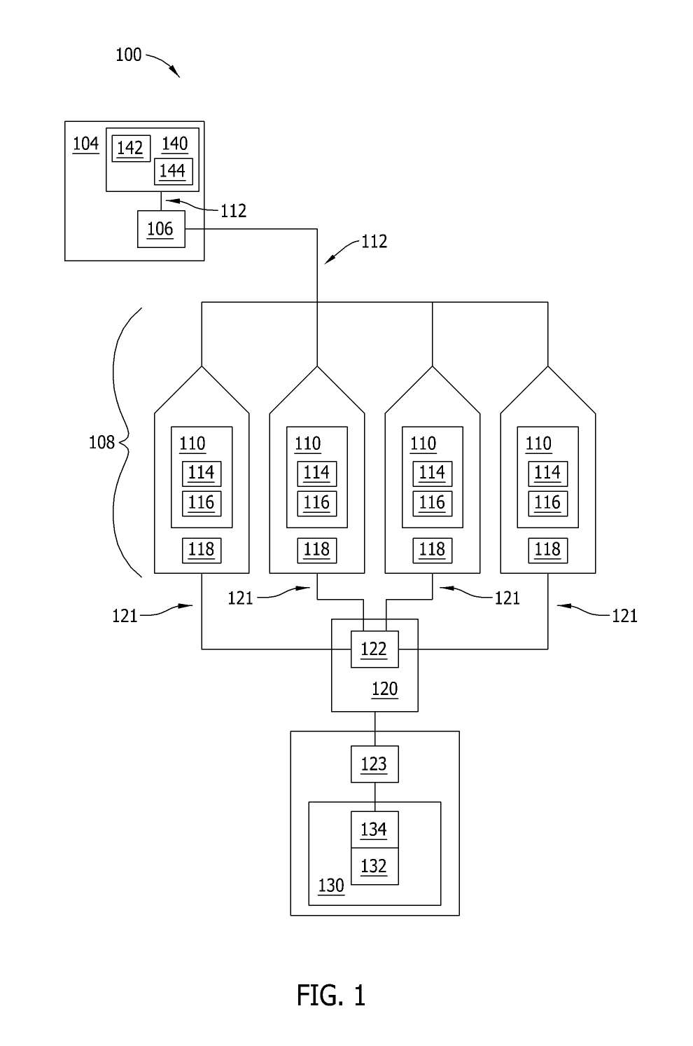

FIG. 1 illustrates a demand response system 100. In the exemplary embodiment, demand response system 100 includes a utility 104 and a computing device 106 positioned within utility 104, wherein computing device 106 enables utility 104 to communicate with customers. Alternatively, computing device 106 may be positioned at another location with respect to utility 104. Moreover, in the exemplary embodiment, computing device 106 is communicatively coupled to a plurality of buildings 108, wherein a plurality of customers may reside. It should be noted that, as used herein, the term “couple” is not limited to a direct mechanical, electrical, and/or communication connection between components, but may also include an indirect mechanical, electrical, and/or communication connection between multiple components.

More specifically, in the exemplary embodiment, computing device 106 is communicatively coupled to at least one user notification device 110 within each building 108 via a network 112 such that computing device 106 may communicate with user notification device 110. In the exemplary embodiment, user notification device 110 may be a computer, a cellular phone, and/or a smart device, including a smart box and/or smart thermostat. Alternatively, user notification device 110 may be any other device that is configured to communicate with computing device 106. In the exemplary embodiment, each user notification device 110 is connected to network 112 and thus, each customer of utility 104 who is the owner and/or user of user notification device 110, has the same network location. Alternatively, each user notification device 110 may be connected to different networks.

Moreover, in the exemplary embodiment, each user notification device 110 includes a user interface 114 that receives at least one input from a user, such as a customer of utility 104. In the exemplary embodiment, user interface 114 may include, for example, a keyboard, a pointing device, a mouse, a stylus, a touch sensitive panel (e.g., a touch pad or a touch screen), a gyroscope, an accelerometer, a position detector, and/or an audio input interface (e.g., including a microphone) that enables the user to input pertinent information.

Moreover, in the exemplary embodiment, each user notification device 110 includes a presentation interface 116 that presents information, such as information regarding demand response programs and/or demand response events that are received from utility 104, input events and/or validation results, to the user. In the exemplary embodiment, presentation interface 116 includes a display adapter (not shown) that is coupled to at least one display device (not shown). More specifically, in the exemplary embodiment, the display device is a visual display device, such as a cathode ray tube (CRT), a liquid crystal display (LCD), an organic LED (OLED) display, and/or an “electronic ink” display. Alternatively, presentation interface 116 may include an audio output device (e.g., an audio adapter and/or a speaker) and/or a printer.

In the exemplary embodiment, computing device 106 may communicate with each user notification device 110 using a wired network connection (e.g., Ethernet or an optical fiber), a wireless communication means, such as radio frequency (RF), e.g., FM radio and/or digital audio broadcasting, an Institute of Electrical and Electronics Engineers (IEEE®) 802.11 standard (e.g., 802.11(g) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. WIMAX is a registered trademark of WiMax Forum, of Beaverton, Oreg. IEEE is a registered trademark of the Institute of Electrical and Electronics Engineers, Inc., of New York, N.Y.

In the exemplary embodiment, user notification device 110 is configured to receive at least one signal from computing device 106 that may be representative of, for example, information related to at least one demand response program that a customer is enrolled in and/or that may be representative of a demand response event initiating and/or implementing the demand response program that the customer is enrolled in. In the exemplary embodiment, the demand response programs may include a direct load control program, a peak pricing program, such as a critical peak pricing program, and/or a time of use program.

In the exemplary embodiment, each building 108 also includes at least one machine 118. Each machine 118, in the exemplary embodiment, consumes energy, such as an appliance and/or a computer. User notification device 110 may or may not be coupled to machine 118. For example, if user notification device 110 is a smart device, then user notification device 110 may be coupled to machine 118, such as an appliance. Moreover, in the exemplary embodiment, each building 108 is coupled to a power distribution substation 120 via a plurality of conduits 121. In the exemplary embodiment, conduits 121 are fabricated from a metallic wire. Alternatively, conduits 121 may be fabricated from any other substance or compound that enables the distribution of electrical energy to each building 108.

More specifically, in the exemplary embodiment, substation 120 includes a grid 122 that is coupled to each building 108 and provides power to each building 108. In the exemplary embodiment, grid 122 is coupled to a generator 123 within a power generation system 124 that is operated by utility 104. In the exemplary embodiment, power generation system 124 includes a machine 130. Machine 130, in the exemplary embodiment, is a variable speed machine, such as a wind turbine, a hydroelectric steam turbine, a gas turbine, and/or any other machine that operates with a variable speed. Alternatively, machine 130 may be a synchronous speed machine. In the exemplary embodiment, machine 130 includes a rotating device 132, such as a rotor or other device. Moreover, in the exemplary embodiment, rotating device 132 rotates a drive shaft 134 that is coupled to generator 123.

In the exemplary embodiment, utility 104 also includes a data management system 140 that is coupled to computing device 106 via network 112. Alternatively, data management system 140 may be separate from utility 104. Data management system 140 may be any device capable of accessing network 112 including, without limitation, a desktop computer, a laptop computer, or other web-based connectable equipment. More specifically, in the exemplary embodiment, data management system 140 includes a database 142 that includes customer data for each of the customers of utility 104. In the exemplary embodiment, database 142 can be fully or partially implemented in a cloud computing environment such that data from the database is received from one or more computers (not shown) within utility 104 or remote from utility 104. In the exemplary embodiment, the customer data may include an enrollment status for each customer for participating in at least one demand response program. For example, the data may include a selection made by each customer for at least one demand response program to participate in. The customer data may also include at least one demand response program selected by each customer for each machine 118 to participate in. Moreover, in the exemplary embodiment, the customer data may include a participation history for each customer. The participation history may include, for example, the previous demand response events that each customer has participated in and the actual reduction in energy consumption that resulted from the participation in each of the events. In the exemplary embodiment, database 142 also includes all of the demand response events that utility 104 has scheduled to implement.

Moreover, in the exemplary embodiment, data management system 140 includes a user interface 144 that receives at least one input from a user, such as an operator and/or employee of utility 104. In the exemplary embodiment, data management system user interface 144 may include, for example, a keyboard, a pointing device, a mouse, a stylus, a touch sensitive panel (e.g., a touch pad or a touch screen), a gyroscope, an accelerometer, a position detector, and/or an audio input interface (e.g., including a microphone) that enables the user to input pertinent information.

Data management system 140 may communicate with computing device 106 using a wired network connection (e.g., Ethernet or an optical fiber), a wireless communication means, such as radio frequency (RF), e.g., FM radio and/or digital audio broadcasting, an Institute of Electrical and Electronics Engineers (IEEE®) 802.11 standard (e.g., 802.11(g) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. More specifically, in the exemplary embodiment, data management system 140 transmits the customer data to computing device 106. While the customer data is shown as being stored in database 142 within data management system 140 in the exemplary embodiment, it should be noted that the customer data may be stored in another system and/or device. For example, computing device 106 may store the customer data therein.

During operation, utility 104 may transmit, for example, a questionnaire to its customers via computing device 106. The questionnaire provides questions to each customer to answer regarding the customer and the questionnaire provides various demand response programs that each customer may elect to participate in. More specifically, in the exemplary embodiment, the questionnaire is transmitted to user notification device 110. Each customer may input various responses to the questionnaire via user interface 114 within user notification device 110, including selecting at least one demand response program to participate in and/or selecting at least one demand response program for machine 118 to participate in. Alternatively, utility 104 may provide such a questionnaire to its customers via other means. For example, utility 104 may send the questionnaire via mail. Moreover, customers may provide responses for the questionnaire to utility 104 via other means, as opposed to via user notification device 110.

In the exemplary embodiment, if a customer provides his or her responses via user notification device 110, then the information that the customer provides is transmitted to computing device 106 via network 112. Computing device 106 then transmits the information to data management system 140, wherein the data is stored in database 142. If a customer provides his or her responses via other means, utility 104 may receive the information and a user, such as an employee of utility 104, may input the data to data management system 140 via data management system user interface 144, wherein the data may be stored in database 142.

When utility 104 needs to initiate and/or implement a demand response program, the user may manually input the initiation and/or implementation of a demand response event to computing device 106 at a particular time. The user may also manually input the names of the customers such that computing device 106 may transmit at least one signal representative of at least one demand response event to the customers that are identified by the user.

Alternatively, computing device 106 may be programmed to select at least one participant from a plurality of customers of utility 104 to participate in at least one demand response event that results in a reduction of energy consumption for the participant. Computing device 106 may also be programmed to determine at least one time of day to transmit at least one signal initiating and/or implementing the demand response program to the selected participants. More specifically, in the exemplary embodiment, computing device 106 receives customer data from database 142 and selects the participants based on the customer data received. For example, the participants selected may be the customers who have enrolled in a demand response program that corresponds to the demand response event that is to be scheduled and/or the customers who have a participation history of participating in similar demand response events.

As explained in more detail below, computing device 106 will then schedule the demand response event for the selected participants. More specifically, in the exemplary embodiment, computing device 106 schedules a start time and/or a duration of time for the demand response event to occur on a particular day of the week. Computing device 106 compares the selected participants with a plurality of participants of previously scheduled demand response event to confirm whether the selected participants can, in fact, participate in the recently scheduled demand response event. For example, such a comparison enables computing device 106 to identify whether any of the selected participants may be scheduled to participate in a previously scheduled demand response event that conflicts with the demand response event. Such a comparison also enables computing device 106 to filter out or remove selected participants who cannot participate in the recently scheduled demand response event. Computing device 106 also compares the demand response event with the previously scheduled demand response events. For example, computing device 106 retrieves information regarding the previously scheduled demand response events from database 142. Computing device 106 will then reschedule the demand response event and/or at least one of the previously scheduled demand response events when any conflicts are identified based on the comparison between the demand response event and the previously scheduled demand response event. In the exemplary embodiment, computing device 106 may also delete the demand response event and/or at least one of the previously scheduled demand response events when any conflicts are identified based on the comparison.

When the demand response event has been scheduled and/or rescheduled if any conflicts are identified, computing device 106 will then transmit at least one signal to each selected participant that is representative of the scheduled demand response event at the scheduled time. The signals may be transmitted to user notification device 110 such that each participant may receive the signal via presentation interface 116. Each participant may then choose whether to participate in the demand response event via user interface 114.

By selectively targeting the participants for participating in a demand response event that is to be scheduled, the burden on every customer may be substantially reduced. In addition, by having computing device 106 schedule demand response events, while confirming whether selected participants can participate in the demand response event and while also taking any scheduling conflicts with previously scheduled demand response events into account, a user, such as an employee of the utility, is no longer required to look at all scheduled demand response events to identify any conflicts and/or to manually reschedule and/or delete demand response events that are in conflict with one another. Accordingly, utility 104 is not burdened with a time consuming and/or inefficient process.

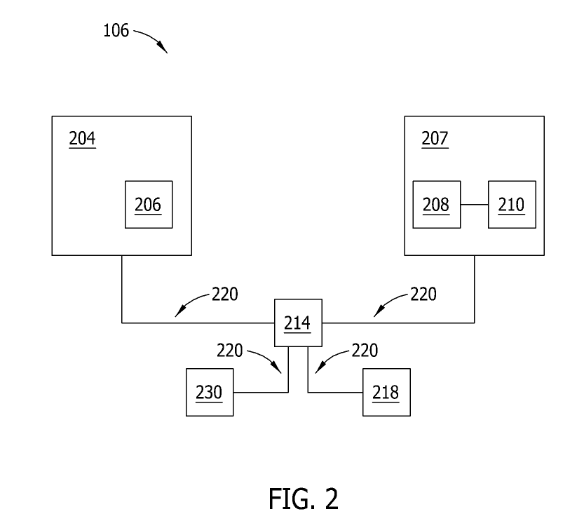

FIG. 2 is a block diagram of computing device 106. In the exemplary embodiment, computing device 106 includes a user interface 204 that receives at least one input from a user, such as an operator and/or employee of utility 104 (shown in FIG. 1). In the exemplary embodiment, user interface 204 includes a keyboard 206 that enables the user to input pertinent information. Alternatively, user interface 204 may include, for example, a pointing device, a mouse, a stylus, a touch sensitive panel (e.g., a touch pad or a touch screen), a gyroscope, an accelerometer, a position detector, and/or an audio input interface (e.g., including a microphone).

Moreover, in the exemplary embodiment, computing device 106 includes a presentation interface 207 that presents information, such as input events and/or validation results, to the user. In the exemplary embodiment, presentation interface 207 includes a display adapter 208 that is coupled to at least one display device 210. More specifically, in the exemplary embodiment, display device 210 is a visual display device, such as a cathode ray tube (CRT), a liquid crystal display (LCD), an organic LED (OLED) display, and/or an “electronic ink” display. Alternatively, presentation interface 207 may include an audio output device (e.g., an audio adapter and/or a speaker) and/or a printer.

Computing device 106 also includes a processor 214 and a memory device 218. In the exemplary embodiment, processor 214 is coupled to user interface 204, presentation interface 207, and to memory device 218 via a system bus 220. In the exemplary embodiment, processor 214 communicates with the user, such as by prompting the user via presentation interface 207 and/or by receiving user inputs via user interface 204.

Moreover, in the exemplary embodiment, processor 214 is programmed by encoding an operation using one or more executable instructions and providing the executable instructions in memory device 218. In the exemplary embodiment, processor 214 is programmed to select at least one participant from the customers of utility 104 to participate in least one demand response event that results in a reduction of energy consumption for the participant. More specifically, in the exemplary embodiment, processor 214 is programmed to select the participants by considering the customer data, such as the enrollment status for each customer for participating in at least one demand response program. For example, processor 214 may consider the selection made by each customer for at least one demand response program to participate in. Processor 214 may also consider at least one demand response program selected by each customer for each machine 118 (shown in FIG. 1) to participate in. Processor 214 may also consider the participation history for each customer, such as the previous demand response events each customer has participated in. Alternatively, processor 214 may select the participants by considering any other information about each customer that enables computing device 106 and/or demand response system 100 (shown in FIG. 1) to function as described herein.

Processor 214, in the exemplary embodiment, is also programmed to schedule the demand response event. More specifically, processor 214 is programmed to schedule a start time for the demand response event to commence on a particular day of the week and/or processor is programmed to schedule a duration of time for the demand response event to take place on the day of the week. In addition, processor 214 is programmed to compare the selected participants with a plurality of participants of a plurality of previously scheduled demand response events to confirm whether the selected participants are, in fact, able to participate in the recently scheduled demand response event. Processor 214 is also programmed to compare the demand response event with the previously scheduled demand response events. More specifically, processor 214 is programmed to make the comparison by analyzing the plurality of previously scheduled demand response events and determining whether any of the plurality of previously scheduled demand response events occur during the same time as the recently scheduled demand response event, such as determining whether they have the same start time and/or whether there is any overlap with the duration of time.

Processor 214, in the exemplary embodiment, is programmed to reschedule and/or delete the demand response event and/or at least one of the previously scheduled demand response events when any conflicts are identified based on the comparison. For example, processor 214 may reschedule and/or delete the demand response event and/or at least one of the previously scheduled demand response events by considering a type of demand response program that corresponds to each demand response event. Moreover, processor 214 may organize the demand response event and the plurality of previously scheduled demand response events in a hierarchy that is based on a projected amount of reduction of energy consumption that would result from participation in each event. For example, the demand response event that results in the greatest amount of reduction in energy consumption would remain scheduled, while any other conflicting events are rescheduled and/or deleted.

The term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, memory device 218 includes one or more devices that enable information, such as executable instructions and/or other data, to be stored and retrieved. Moreover, in the exemplary embodiment, memory device 218 includes one or more computer readable media, such as, without limitation, dynamic random access memory (DRAM), static random access memory (SRAM), a solid state disk, and/or a hard disk. In the exemplary embodiment, memory device 218 stores, without limitation, application source code, application object code, configuration data, additional input events, application states, assertion statements, validation results, and/or any other type of data. More specifically, in the exemplary embodiment, memory device 218 stores input data received by a user via user interface 204, and/or information received from other components of demand response system 100 (shown in FIG. 1), such as from user notification device 110 (shown in FIG. 1) and/or data management system 140 (shown in FIG. 1).

Computing device 106, in the exemplary embodiment, also includes a communication interface 230 that is coupled to processor 214 via system bus 220. Moreover, in the exemplary embodiment, communication interface 230 is communicatively coupled to user notification device 110 and data management system 140 via network 112 (shown in FIG. 1). In the exemplary embodiment, communication interface 230 communicates with user notification device 110, data management system 140, and/or other components within system 100.

During operation, when utility 104 needs to initiate and/or implement a demand response program, the user may manually input the initiation and/or implementation of a demand response event to computing device 106 at a particular time. The user may also manually input the names of the customers such that computing device 106 may transmit at least one signal representative of at least one demand response event to the customers that are identified by the user.

Alternatively, computing device 106 may be programmed to select at least one participant of a plurality of customers of utility 104 for participating in at least one demand response event that results in a reduction of energy consumption. More specifically, in the exemplary embodiment, processor 214 transmits a signal via communication interface 230 to data management system 140 to retrieve customer data from database 142. Customer data is transmitted from database 142 to computing device 106, wherein communication interface 230 receives the data and transmits the data to processor 214. Processor 214 selects and identifies at least one participant from the customers to participate in at least one demand response event. More specifically, in the exemplary embodiment, processor 214 selects the participants by considering the customer data, such as the enrollment status for each customer for participating in at least one demand response program. For example, processor 214 considers the selection made by each customer for at least one demand response program to participate in. Processor 214 may also consider at least one demand response program selected by each customer for each machine 118 to participate in. Processor 214 may also consider the participation history for each customer, such as the previous demand response events each customer has participated in. For example, a customer who has participated in a similar demand response event in the past will likely be selected. Alternatively, processor 214 may select the participants by considering any other information about each customer that enables computing device 106 and demand response system 100 to function as described herein.

When participants have been selected for participating in a demand response event, processor 214 then schedules the demand response event. In the exemplary embodiment, processor 214 schedules a start time for the demand response event to commence on a particular day of the week and schedules the demand response event for a specific duration of time. For example, processor 214 may schedule the demand response event to start at 10:00 a.m. on Monday and to occur for a period of thirty minutes.

Processor 214 then compares the selected participants with a plurality of participants of a plurality of previously scheduled demand response events to confirm whether the selected participants are, in fact, able to participate in the recently scheduled demand response event. More specifically, in the exemplary embodiment, processor 214 transmits a signal via communication interface 230 to data management system 140 to retrieve information regarding each of the selected participants and their participation in previously scheduled demand response events. Such a comparison enables computing device 106 to identify whether any of the selected participants may be scheduled to participate in a previously scheduled demand response event that conflicts with the demand response event. Such a comparison also enables computing device 106 to filter out or remove selected participants who cannot participate in the recently scheduled demand response event.

Processor 214 also compares the recently scheduled demand response event with the previously scheduled demand response events. More specifically, in the exemplary embodiment, processor 214 transmits a signal via communication interface 230 to data management system 140 to retrieve information regarding previously scheduled demand response events, such as their start time and/or duration of time for each event, from database 142. The information is transmitted from database 142 to computing device 106, wherein communication interface 230 receives the information and transmits the information to processor 214. Processor 214 then analyzes the plurality of previously scheduled demand response events and determines whether any of the previously scheduled demand response events occur during the same time as the recently scheduled demand response event, such as determining whether they have the same start time and/or whether there is any overlap with the duration of time.

When any conflicts are identified based on the comparison, processor 214 reschedules and/or deletes the recently scheduled demand response event and/or the at least one of the previously scheduled demand response events. More specifically, processor 214 may consider a type of demand response program that corresponds to each demand response event. For example, if the recently scheduled demand response event occurs at the same time as one of the previously scheduled demand response events, wherein the recently scheduled event corresponds to a time of use program and the other event corresponds to a peak pricing event, processor 214 may reschedule and/or delete the recently scheduled program because the event that corresponds to the peak pricing event would likely result in a greater reduction of energy consumption and/or have a greater amount of participation success.

If, for example, the recently scheduled demand response event conflicts with several of the previously scheduled demand response events, processor 214 may organize each event in a hierarchy that is based on a projected amount of reduction of energy consumption that would result from participation in each event. For example, the event that results in the greatest amount of reduction in energy consumption would be positioned in a first tier of the hierarchy, while the event that results in the lowest amount of reduction in energy consumption would be positioned in a last tier of the hierarchy. The event positioned in the first tier of the hierarchy would then remain as scheduled, while the other events may be rescheduled and/or deleted based on the hierarchy.

The changes in the schedule for each demand response event is presented to the user via display device 210 within presentation interface 207. The user may accept the scheduling changes or make any additional changes via user interface 204. The changes in the schedule for each demand response event are also transmitted via communication interface 230 to data management system 140. More specifically, the changes are transmitted to database 142 for storage.

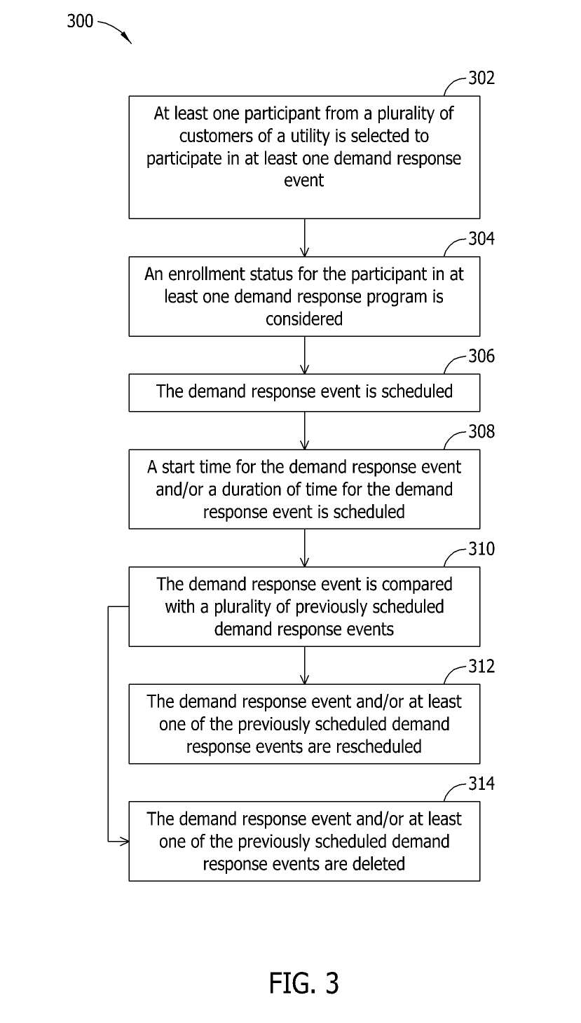

FIG. 3 is a flow chart of a method 300 that may be used for scheduling demand response events using a computing device, such as computing device 106 (shown in FIGS. 1 and 2). At least one participant from a plurality of customers of a utility 104 (shown in FIG. 1) are selected 302, via a processor 214 (shown in FIG. 2), to participate in at least one demand response event that results in a reduction of energy consumption for the participant. When at least one participant is selected 302, an enrollment status for the participant in at least one demand response program is considered 304.

The demand response event is scheduled 306 via processor 214. More specifically, when the demand response event is scheduled 306, a start time for the demand response event and/or a duration of time for the demand response event is scheduled 308. The selected participant is compared 309 with a plurality of participants of a plurality of previously scheduled demand response events, via processor 214, to confirm whether the selected participant can participate in the recently scheduled demand response event. The demand response event is also compared 310 with the plurality of previously scheduled demand response events via processor 214. The demand response event and/or at least one of the previously scheduled demand response events are rescheduled 312, via processor 214, when any conflicts are identified based on the comparison between the demand response event and the previously scheduled demand response events. Alternatively, the demand response event and/or at least one of the previously scheduled demand response events are deleted 314 via processor 214.

As compared to known demand response systems that are used to enable utilities to manage energy consumption by the implementation of demand response programs, the exemplary systems and methods described herein provide an efficient and user friendly demand response system that can be used by a utility to schedule demand response events. The embodiments described herein include a demand response system that includes a computing device, wherein the computing device includes a processor that is programmed to select at least one participant from a plurality of customers of a utility to participate in at least one demand response event. The processor is also programmed to schedule the demand response event. The processor is programmed to compare the selected participant with a plurality of participants of a plurality of previously scheduled demand response events to confirm whether the selected participant is able to participate in the demand response event. The processor is also programmed to compare the demand response event with the previously scheduled demand response events. The processor is further programmed to reschedule the demand response event and/or at least one of the previously scheduled demand response events when any conflicts are identified based on the comparison between the demand response event and the previously scheduled demand response events. By selectively targeting only certain customers for participating in a demand response event that is to be scheduled, the burden on every customer may be substantially reduced. In addition, by having the computing device schedule demand response events, while confirming whether selected participants can participate in the demand response event and also while taking any scheduling conflicts with previously scheduled demand response events into account, a user, such as an employee of the utility, is no longer required to look at all scheduled demand response events to identify any conflicts and/or to manually reschedule and/or delete demand response events that are in conflict with one another. Accordingly, the utility is not burdened with a time consuming and/or inefficient process.

A technical effect of the systems and methods described herein includes at least one of: (a) selecting at least one participant from a plurality of customers of a utility to participate in at least one demand response event that results in a reduction of energy consumption for the participant; (b) scheduling at least one demand response event; (c) comparing at least one selected participant with a plurality of participants of a plurality of previously scheduled to confirm whether the selected participant is able to participate in at least one demand response event; (d) comparing at least one demand response event with a plurality of previously scheduled demand response events; and (e) rescheduling at least one of at least one demand response event and at least one of a plurality of previously scheduled demand response events when any conflicts are identified based on a comparison.

Exemplary embodiments of the systems and methods are described above in detail. The systems and methods are not limited to the specific embodiments described herein, but rather, components of the systems and/or steps of the methods may be utilized independently and separately from other components and/or steps described herein. For example, the systems may also be used in combination with other systems and methods, and is not limited to practice with only the systems as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device for use with a demand response system, said computing device comprising a processor programmed to:
select at least one participant from a plurality of customers to participate in at least one demand response event;
schedule the at least one demand response event;
compare the selected at least one participant with a plurality of participants of a plurality of previously scheduled demand response events to confirm whether the selected at least one participant is able to participate in the at least one demand response event;
compare the at least one demand response event with the plurality of previously scheduled demand response events; and
reschedule at least one of the at least one demand response event and at least one of the plurality of previously scheduled demand response events when any conflicts are identified based on the comparison between the at least one demand response event and the plurality of previously scheduled demand response events.

2. A computing device in accordance with claim 1, wherein said processor selects the at least one participant based on an enrollment status for the at least one participant in at least one demand response program.

3. A computing device in accordance with claim 1, wherein said processor schedules the at least one demand response event by scheduling at least one of a start time for the at least one demand response event and a duration of time for the at least one demand response event.

4. A computing device in accordance with claim 1, wherein said processor compares the at least one demand response event with the plurality of previously scheduled demand response events by analyzing the plurality of previously scheduled demand response events and determining whether any of the plurality of previously scheduled demand response events occur during the same time as the at least one demand response event.

5. A computing device in accordance with claim 1, wherein said processor reschedules at least one of the at least one demand response event and at least one of the plurality of previously scheduled demand response events based on a type of demand response program that corresponds to each demand response event.

6. A computing device in accordance with claim 1, wherein said processor reschedules at least one of the at least one demand response event and at least one of the plurality of previously scheduled demand response events by organizing the at least one demand response event and the plurality of previously scheduled demand response events in a hierarchy based on a projected amount of reduction of energy consumption that would result from each of the at least one demand response event and the plurality of previously scheduled demand response events.

7. A computing device in accordance with claim 1, wherein said processor is further programmed to delete at least one of the at least one demand response event and the plurality of previously scheduled demand response events when any conflicts are identified based on the comparison between the at least one demand response event and the plurality of previously scheduled demand response events.

8. A demand response system comprising:
a data management system comprising a database that includes customer data of a plurality of customers, wherein the customer data includes an enrollment status for each customer in at least one demand response program;
a computing device coupled to said data management system, wherein said computing device comprises an interface for receiving the customer data and a processor coupled to said interface, said processor is programmed to:
select at least one participant from the plurality of customers to participate in at least one demand response event;
schedule the at least one demand response event;
compare the selected at least one participant with a plurality of participants of a plurality of previously scheduled demand response events to confirm whether the selected at least one participant is able to participate in the at least one demand response event;
compare the at least one demand response event with the plurality of previously scheduled demand response events; and
reschedule at least one of the at least one demand response event and at least one of the plurality of previously scheduled demand response events when any conflicts are identified based on the comparison between the at least one demand response event and the plurality of previously scheduled demand response events.

9. A demand response system in accordance with claim 8, wherein said processor selects the at least one participant based on an enrollment status for the at least one participant in the at least one demand response program.

10. A demand response system in accordance with claim 8, wherein said processor schedules the at least one demand response event by scheduling at least one of a start time for the at least one demand response event and a duration of time for the at least one demand response event.

11. A demand response system in accordance with claim 8, wherein said processor compares the at least one demand response event with the plurality of previously scheduled demand response events by analyzing the plurality of previously scheduled demand response events and determining whether any of the plurality of previously scheduled demand response events occur during the same time as the at least one demand response event.

12. A demand response system in accordance with claim 8, wherein said processor reschedules at least one of the at least one demand response event and at least on of the plurality of previously scheduled demand response events based on the type of demand response program that corresponds to each demand response event.

13. A demand response system in accordance with claim 8, wherein said processor reschedules at least one of the at least one demand response event and at least one of the plurality of previously scheduled demand response events based on a type of demand response program that corresponds to each demand response event.

14. A demand response system in accordance with claim 8, wherein said processor is further programmed to delete at least one of the at least one demand response event and the plurality of previously scheduled demand response events when any conflicts are identified based on the comparison between the at least one demand response event and the plurality of previously scheduled demand response events.

15. A method for scheduling demand response events, said method comprising:
selecting at least one participant from a plurality of customers to participate in at least one demand response event;
scheduling the at least one demand response event;
comparing the selected at least one participant with a plurality of participants of a plurality of previously scheduled demand response events to confirm whether the selected at least one participant is able to participate in the at least one demand response event;
comparing the at least one demand response event with the plurality of previously scheduled demand response events; and
rescheduling at least one of the at least one demand response event and at least one of the plurality of previously scheduled demand response events when any conflicts are identified based on the comparison between the at least one demand response event and the plurality of previously scheduled demand response events.

16. A method in accordance with claim 15, wherein selecting at least one participant further comprises selecting at least one participant based on an enrollment status for the at least one participant in at least one demand response program.

17. A method in accordance with claim 15, wherein scheduling the at least one demand response event further comprises scheduling the at least one demand response event by scheduling at least one of a start time for the at least one demand response event and a duration of time for the at least one demand response event.

18. A method in accordance with claim 15, wherein comparing the at least one demand response event further comprises comparing the at least one demand response event with a plurality of previously scheduled demand response events by analyzing the plurality of previously scheduled demand response events and determining whether any of the plurality of previously scheduled demand response events occur during the same time as the at least one demand response event.

19. A method in accordance with claim 15, wherein rescheduling at least one of the at least one demand response event further comprises rescheduling at least one of the at least one demand response event and at least one of the plurality of previously scheduled demand response events based on a type of demand response program that corresponds to each demand response event.

20. A method in accordance with claim 15, wherein rescheduling at least one of the at least one demand response event further comprises rescheduling at least one of the at least one demand response event and at least one of the plurality of previously scheduled demand response events by organizing the at least one demand response event and the plurality of previously scheduled demand response events in a hierarchy based on a projected amount of reduction of energy consumption that would result from each of the at least one demand response event and the plurality of previously scheduled demand response events.
